(19) United States
(12) Patent Application Publication
(10) Pub. No.: US 2016/0219909 A1
(43) Pub. Date: Aug. 4, 2016

(54) STABLE RED FORMULATIONS FOR THE COLORATION OF BEVERAGES AND FOOD

(71) Applicant: DSM IP ASSETS B.V., Tel Heerlen (NL)

(72) Inventors: Hansjoerg GRASS, Basel (CH); Andrea HITZFELD, Basel (CH)

(21) Appl. No.: 14/917,740

(22) PCT Filed: Sep. 24, 2014
(86) PCT No.: PCT/EP2014/070386

§ 371 Date: Mar. 9, 2016

(30) Foreign Application Priority Data
Sep. 24, 2013 (CH) 01657/13

(51) Int. Cl. A23L 1/0522; A23L 2/58; A23G 1/32; A23L 1/303

(52) U.S. Cl. CPC A23L 1/2753; A23L 2/58; A23G 1/32; A23V 2002/00

(57) ABSTRACT

The present invention is directed to stable red formulations comprising rhodoxanthin embedded in a matrix of modified food starch, their manufacturing process as well as to the use of such formulations for coloring, enriching or fortifying beverages and food products and such beverages and food products which show an intense red color.

The present invention is directed to stable red formulations comprising rhodoxanthin embedded in a matrix of modified food starch. Such formulations are compositions which cannot be found in nature as such and which may preferably be manufactured by a process as disclosed in EP-A 937 412 for the manufacture of carotenoid formulations.

At present there is a high demand of replacing currently used artificial azo dyes in food and beverages by “natural” colorants. Thus, according to the present invention the formulations, as well as the beverages and the food products containing such formulations do not contain any azo dyes. Furthermore it is desired that the color of such beverages and food products containing natural colorants is the same or nearly the same color of the beverages and food products that contained the artificial azo dyes. Thus, the color appearance of such beverages and food products should be maintained and not changed.

Until now no replacement was found that gives an intense red color to beverages and food products and which is not of animal origin. Furthermore, it is also an object of the present invention to provide a simple process for the manufacture of formulations which can be used in an industrial scale to produce large amounts of such formulations.

These objects are met with the rhodoxanthin formulations according to the present invention whereby the rhodoxanthin is embedded in a matrix of modified food starch. Thus, the rhodoxanthin is protected against degradation by oxidation. Surprisingly these formulations give an intense red color to beverages and food products they are incorporated in.

Preferably the color hue of the rhodoxanthin formulation of the present invention is in the range of from 30 to 45, preferably in the range of from 35 to 45, more preferably in the range of from 35 to 40, if said formulation is mixed with water so that the mixture contains 1 to 20 ppm, preferably 5 to 10 ppm, of rhodoxanthin. In this concentration the mixture with water looks red.

Rhodoxanthin (compound of formula I) can be obtained from a natural source, by fermentation or by chemical synthesis. A natural source might be conifers, e.g. plants of Taxus baccata, or Aloa sp. (see e.g. Merzlyak et al., Photochem Photobiol Sci 2005, 4, 333-340). Chemical syntheses are e.g. described in EP-A 077 439 and EP-A 085 763.

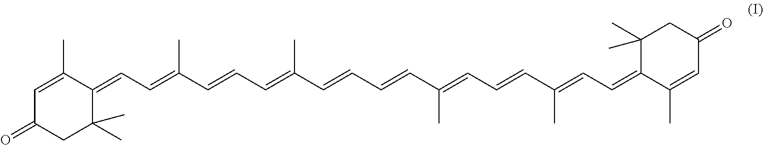 [SMILES: CC1=CC(=O)CC(C)(C)\C1=C/C=C(C)/C=C/C=C(C)/C=C/C=C/C(C)=C/C=C/C(C)=C/C=C1/C(C)=CC(=O)CC1(C)C]

The term “rhodoxanthin” as used herein not only encompasses the (all-E)-isomer, but also any of its mono-, oligo- or poly-(Z)-isomers.

The formulation according to the present invention comprises preferably 0.1 to 25 weight-%, more preferably 0.5 to 20.0 weight-%, even more preferably 1 to 15.0 weight-%, most preferably 5.0 to 10.0 weight-%, of rhodoxanthin, based on the total weight of the formulation.

### “Modified Food Starch”

A modified food starch is a food starch that has been chemically modified by known methods to have a chemical structure which provides it with a hydrophilic and a lipophilic portion. Preferably the modified food starch has a long hydrocarbon chain as part of its structure (preferably C5-C18).

At least one modified food starch is preferably used to make a formulation of this invention, but it is possible to use a mixture of two or more different modified food starches in one formulation.

Starches are hydrophilic and therefore do not have emulsifying capacities.

However, modified food starches are made from starches substituted by known chemical methods with hydrophobic moieties. For example starch may be treated with cyclic dicarboxylic acid anhydrides such as succinic anhydrides, substituted with a hydrocarbon chain (see 0. B. Wurzburg (editor), “Modified Starches: Properties and Uses, CRC Press, Inc. Boca Raton, Fla., 1986, and subsequent editions). A particularly preferred modified food starch of this invention has the following formula (I)

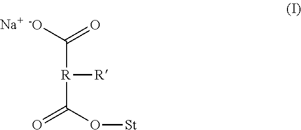

wherein St is a starch, R is an alkylene radical and R′ is a hydrophobic group. Preferably R is a lower alkylene radical such as dimethylene or trimethylene. R′ may be an alkyl or alkenyl group, preferably having 5 to 18 carbon atoms. A preferred compound of formula (I) is an “OSA-starch” (starch sodium octenyl succinate). The degree/extent of substitution, i.e. the number of esterified hydroxyl groups to the number of free non-esterified hydroxyl groups usually varies in a range of from 0.1% to 10%, preferably in a range of from 0.5% to 4%, more preferably in a range of from 3% to 4%.

The term “OSA-starch” denotes any starch (from any natural source such as corn, waxy maize, waxy corn, wheat, tapioca and potato or synthesized) that was treated with octenyl succinic anhydride (OSA). The degree/extent of substitution, i.e. the number of hydroxyl groups esterified with OSA to the number of free non-esterified hydroxyl groups usually varies in a range of from 0.1% to 10%, preferably in a range of from 0.5% to 4%, more preferably in a range of from 3% to 4%. OSA-starches are also known under the expression “modified food starch”.

The term “OSA-starches” encompasses also such starches that are commercially available e.g. from National Starch/Ingredion under the tradenames HiCap 100, Capsul, Capsul HS, Purity Gum 2000, Clear Gum Co03, UNI-PURE, HYLON VII; from National Starch/Ingredion and Roquette Frères, respectively; from CereStar under the tradename C*EmCap or from Tate & Lyle.

In a preferred embodiment of the present invention a commercially available modified food starch such as e.g. HiCap 100 (from National Starch/Ingredion) and ClearGum Co03 (from Roquette Frères) is used. It is especially advantageous if such a starch or an OSA starch in general is further improved according to a process as disclosed in WO 2007/090614, especially according to a procedure as described in examples 28, 35 and/or 36 of WO 2007/090614.

Thus, in a further improved embodiment of the present invention such a commercially available starch has been centrifuged as an aqueous solution or suspension before use. The centrifugation may be carried out at 1000 to 20000 g depending on the dry mass content of the modified food starch in the aqueous solution or suspension. If the dry mass content of the modified food starch in the aqueous solution or suspension is high, the applied centrifugation force is also high. For example for an aqueous solution or suspension with a dry mass content of the modified food starch of 30 weight-% a centrifugation force of 12000 g may be suitable to achieve the desired separation.

The centrifugation may be carried out at dry matter contents in the range of from 0.1-60 weight-%, preferably in the range of from 10-50 weight-%, most preferably in the range of from 15-40 weight-% at temperatures in the range of from 2-99° C., preferably in the range of from 10-75° C., most preferably in the range of from 40-60° C.

The formulation according to the present invention comprises preferably 60 to 99.8 weight-%, more preferably 70 to 90 weight-%, of modified food starch based on the total weight of the formulation, whereby the preferred modified food starch is commercially available OSA-starch, which is preferably further improved by separating off insoluble parts as disclosed e.g. in WO 2007/090614 (examples for centrifugation and microfiltration). If a mixture of two or more modified food starches is present the total amount is also in the ranges as given above.

### Further Ingredients

### Fat-Soluble Anti-Oxidants

Suitable fat-soluble antioxidants are known to the person skilled in the art. Preferably fat-soluble antioxidants are used that are approved for their application in food products and beverages.

Preferred fat-soluble antioxidants are selected from the group consisting of tocopherols, e.g. dl-α-tocopherol (i.e. synthetic tocopherol), d-α-tocopherol (i.e. natural tocopherol), β- or γ-tocopherol, or a mixture of two or more of these.

The most preferred fat-soluble antioxidant is dl-α-tocopherol.

Preferably the total amount of the fat-soluble antioxidants in the formulation according to the present invention is in the range of from 0 to 1.5 weight-%, more preferably it is in the range of from 0.01 to 1.0 weight-%, most preferably it is in the range of from 0.1 to 0.5 weight-%, based on the total weight of the formulation.

### Water-Soluble Anti-Oxidants

Suitable water-soluble antioxidants are known to the person skilled in the art. Preferably water-soluble antioxidants are used that are approved for their application in food products and beverages.

Preferred water-soluble antioxidants are selected from the group consisting of citric acid, citric acid salts, ascorbic acid, ascorbic acid salts (preferably sodium ascorbate), as well as any mixture thereof.

Preferred water-soluble antioxidants are ascorbic acid, sodium ascorbate and citric acid.

Preferably the total amount of the water-soluble antioxidants in the formulation according to the present invention is in the range of from 0.1 to 4.0 weight-%, more preferably it is in the range of from 0.1 to 2.0 weight-%, based on the total weight of the formulation.

A preferred embodiment of the present invention is a stable red formulation consisting of rhodoxanthin, a starch that was treated with octenyl succinic anhydride, and an antioxidant, whereby the antioxidant can be fat-soluble or water-soluble, with the preferred amounts as given above. Such formulation shows an intense red color.

### Additional Compounds of the Formulation According to the Present Invention

Suitably, the formulations of the present invention may further contain an oil.

The amount of said oil is preferably in the range of from 0 to 5.0 weight-%, more preferably in range of from 0.01 to 1.0 weight-%, most preferably in the range of from 0.5 to 1.0 weight-%, based on the total weight of the formulation.

The term “oil” in the context of the present invention encompasses glycerol and any triglyceride such as vegetable oils or fats like corn oil, sunflower oil, soybean oil, safflower oil, rapeseed oil, peanut oil, palm oil, palm kernel oil, cotton seed oil, olive oil or coconut oil.

The oils can be from any origin. They can be natural, modified or synthetic. If the oils are natural they can be plant or animal oils. The term “oil” in the context of the present invention thus also encompasses canola oil, sesame oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil or polyunsaturated fatty acids (=“PUFAs”) (for example arachidonic acid, eicosapentaenoic acid, docosahexaenoic acid and γ-linolenic acid) as well as the triglycerides of PUFAs and the esters of PUFAs, e.g. the ethyl esters of PUFAs.

Compounds not being Present

In a preferred embodiment of the present invention the formulations are essentially free of the following compounds: polyglycerol esters of edible fatty acids, citric acid esters of monoglycerides of edible fatty esters, citric acid esters of diglycerides of edible fatty esters and any mixture thereof. An edible fatty acid is a saturated fatty acid or an unsaturated fatty acid, which has been approved for use in foodstuffs. The edible fatty acid is preferably a fatty acid selected from the group comprising palmitic acid, stearic acid, oleic acid and erucic acid. The esterified fatty acids can be the same or differ from one another.

In a further preferred embodiment of the present invention the formulations are essentially free of physiologically tolerated polyhydric alcohols. Such physiologically tolerated polyhydric alcohols are especially glycerol, monoesters of glycerol with C₁-C₅-monocarboxylic acids, monoethers of glycerol, propylene glycol or sorbitol. Thus, formulations of the present invention are preferably essentially free of glycerol, monoesters of glycerol with C₁-C₅-monocarboxylic acids, monoethers of glycerol, propylene glycol and sorbitol.

In an especially preferred embodiment of the present invention the formulations are essentially free of all the following compounds: polyglycerol esters of edible fatty acids, citric acid esters of monoglycerides of edible fatty esters, citric acid esters of diglycerides of edible fatty esters, physiologically tolerated polyhydric alcohols and any mixture thereof.

“Essentially free” in the context of the present invention means that these compounds are not added to the formulations of the present invention. If, however, these compounds are present in the formulations of the present invention their amount is below 0.5 weight-%, preferably their amount is below 0.1 weight-%, more preferably their amount is 0 weight-%, based on the total weight of the formulation.

The present invention also encompasses any combination of preferred features of the formulations as disclosed above though not explicitly mentioned.

### Process for the Manufacture of the Formulations According to the Present Invention

The present invention is further related to a process for the manufacture of a formulation according to the present invention comprising the following steps:
a) forming a solution of rhodoxanthin in an organic solvent, optionally adding a fat-soluble antioxidant and/or an oil;
b) dissolving a modified food starch and optionally a water-soluble antioxidant in water to obtain a matrix;
c) emulsifying the solution obtained in step a) into the matrix obtained in step b) to obtain an emulsion,
d) removing the organic solvent from the emulsion obtained in step c) to obtain a liquid formulation,
e) optionally drying the liquid formulation obtained in step d) to obtain the solid formulation.

The steps are described in more detail below.

### Step a)

An oil can also be added. If it is, however, added, the amount is chosen so that the final amount of the oil in the resulting formulation after having performed all steps is as described above.

The same applies for the other compounds: the amounts of rhodoxanthin and the fat-soluble antioxidant (if present) are chosen so that the final amounts of these compounds in the resulting formulation after having performed all steps is as described above.

The amount of the solvent and the dissolution temperature are chosen so as to dissolve the rhodoxanthin, the fat-soluble antioxidant, if present, and the oil, if present, completely. Usually it is necessary to heat up the suspension obtained when mixing all compounds present in this step to get a solution. Preferably the temperature to which the suspension is heated up is in the range of from 40 to 90° C., more preferably that temperature is in the range of from 40 to 86° C. After having obtained the solution it is usually kept at the temperature it was before heated up to.

### Step b)

Preferably this step is performed at a temperature in the range of 50 to 70° C., more preferably at a temperature in the range of 55° C. to 67° C., even more preferably at a temperature of around 60° C.

The matrix obtained after having performed step b) is then preferably kept at a temperature in the range of 25 to 65° C., more preferably at a temperature in the range of 29° C. to 66° C., even more preferably at a temperature in the range of 29 to 56° C. Depending on the temperature step b) has been performed it may be necessary to cool the matrix down to such a temperature or to heat it up to such a temperature. In most cases the temperature at which step b) is performed and the temperature at which the matrix is kept are chosen in such a way so that a cooling down step is necessary.

### Step c)

Preferably this step is performed at a mixing temperature in the range of 25 to 100° C., more preferably at a mixing temperature in the range of 30 to 80° C., even more preferably at a mixing temperature in the range of 35° C. to 75° C. to obtain an emulsion.

The emulsification can be achieved by using a rotor-stator device or a high pressure homogenizer or both. Other devices known to the person skilled in the art may also be used.

If rotor-stator device and/or a high pressure homogenizer is used, a pressure drop in the range of 100 to 1000 bar, more preferably in the range of 150 to 300 bar, is preferably applied.

### Step d)

The organic solvent may e.g. be removed by using a thin film evaporator cascade (preferred). Other methods known to the person skilled in the art are also applicable. The resulting liquid formulations can already also be incorporated in beverages and food products to color them with an intense red color.

### Step e)

The resulting formulations after having performed steps a) to d) can also be dried by any method known to the person skilled in the art, e.g. by spray-drying, spray-drying in combination with fluidised bed granulation or by a powder-catch technique, whereby the sprayed emulsion droplets are caught in a bed of an absorbent, such as starch, and subsequently dried.

Preferably the formulations of the present invention are prepared according to the process of the present invention. Thus, the present invention is also directed to the formulation as obtained by the process as described above.

The formulations according to the present invention are used for the enrichment, fortification and/or coloration of beverages and food products; said use being a further aspect of the invention.

Other aspects of the invention are beverages containing a formulation as described above.

Beverages wherein the formulations of the present invention can be used as a colorant or a functional ingredient can be non-alcoholic, flavoured drinks, e.g. flavoured seltzer waters, soft drinks, mineral drinks, flavoured waters, fruit juices, fruit nectars, fruit punches and concentrated forms of these beverages. They may be based on natural fruit or vegetable juices or on artificial juice flavours, and they may be carbonated or non-carbonated. Alcoholic beverages, instant beverage powders, sugar-containing beverages and diet beverages containing non-calorific or artificial sweeteners are further examples of beverages which, by virtue of their containing the rhodoxanthin formulations, are embraced by the present invention.

Also included within the scope of the present invention are sweet products containing the rhodoxanthin as a coloring agent, said sweet products including sugar coated confectionery products, e.g. chocolate lentils, boiled sweets, gums, chewing gums, jellies, toffees, hard sugar candies, soft sugar candies and fudges, as well as chocolate confectionery products; and desserts, including frozen desserts, e.g. sorbets, puddings, instant pudding powders and preserves.

Sweet products, especially hard and soft sugar candies, as well as chocolate lentils and beverages are especially preferred.

Furthermore, dairy products obtained from natural sources are within the scope of the food products in which the rhodoxanthin formulations are present, and as such embraced by the present invention. Typical examples of such dairy products are milk drinks, butter, cheese, ice cream, yoghurt, yoghurt drinks and the like. Milk substitute products such as soy milk products and synthetically produced milk substitute products are also included in the food products containing the rhodoxanthin formulations according to the present invention.

Also included within the scope of the present invention are fat-based products, e.g. spreads, including low fat spreads and margarine; low calorific food products containing natural or synthetically produced fat replacers; cereals and cereal products, e.g. cookies, cakes and pasta; and snacks, e.g. extruded or non-extruded potato-based products, all of which contain the rhodoxanthin formulations as a coloring or fortifying agent.

The total concentration of the rhodoxanthin used as a coloring agent in the food products in accordance with the present invention may be from 0.1 to 500 ppm, preferably from 1 to 50 ppm, based on the total weight of the food product. Clearly, the concentration range in any particular case depends on the particular food product to be colored and on the intended grade of coloration in such food product. The same amounts also apply for beverages.

The beverages or food products of this invention are obtained by adding to or incorporating in the beverage or food product—at a suitable stage in its manufacture—the rhodoxanthin formulation of this invention. For such coloration of a beverage or food product the formulation of this invention can be used according to methods per se known for the application of water- or oil-dispersible solid or liquid forms to beverages or food products, as appropriate.

For the coloration of a beverage or food product the rhodoxanthin formulation may in general be added either as an aqueous stock solution, a dry powder mix or a pre-blend with other suitable food ingredients according to the specific application. Mixing can be effected for example using a dry powder blender, a shear mixer or a homogenizer, depending on the required nature of the final food product or beverage. The particular mixing procedure and amount of oily or aqueous ingredients may influence the color of the final food product or beverage. As will be readily apparent, such technicalities are within the skill of the expert in the art of beverage and food manufacture and formulation.

The beverages and food products colored by the rhodoxanthin formulations show an intense red color. Furthermore such beverages show a low turbidity, especially a turbidity≦150 NTU.

The invention is now further illustrated in the following non-limiting examples.

### EXAMPLES 1-3

### Manufacture of a Rhodoxanthin Formulation

### EXAMPLE 1

### Rhodoxanthin 5% CWS/S

10 g of crystalline rhodoxanthin, 1.3 g of dl-α-tocopherol and 4.6 g of corn oil are dissolved in an appropriate solvent (oil phase). This solution is added under stirring to a solution of 100.8 g of an OSA starch and 240 g water at 50-60° C. This pre-emulsion is homogenized with a rotor-stator-homogenizer for 20 minutes. Eventually the emulsion is homogenized with a high pressure homogenizer. In the next step the remaining solvent is removed by distillation and the solvent-free emulsion is dried by a standard powder catch process. 156 g of beadlets are obtained with a rhodoxanthin content of 4.5%.

The color intensity E1/1 is the absorbance of a 1% solution and a thickness of 1 cm and is calculated as follows: E1/1=(Amax−A650)*dilution factor/(weight of sample*content of product form in %).

“(Amax-A650)” means the value you get when you subtract the Adsorption value measured at 650 nm (“A650”) wavelength from the value (“Amax”) that was measured at the maximum Adsorption in the UV-Spectrophotometer.

“*” means “multiplied with”.
“dilution factor”=the factor by which the solution has been diluted.
“weight of sample”=the amount/weight of the formulation that was used in [g]
“content of product form in %”=“the amount of rhodoxanthin in the beadlet in %” which is 4.5 in the present case.

E1/1_{corr.} in H₂O (λmax)=1595 (481 nm)

### Color Values:

Measured as 5 ppm solution in H₂O: L*/a*/b*=71/35/26; L*/C*/h=71/44/37

Measured as 10 ppm solution in H₂O: L*/a*/b*=54/53/43; L*/C*/h=54/68/39

### EXAMPLE 2

Example 1 may be repeated, but no corn oil added.

### EXAMPLE 3

Example 1 may be repeated, but a different oil may be used.

### EXAMPLE 4

### Preparation of a Soft Drink with the Formulation According to Example 1

The soft drink has the following composition:

| | Ingredient | Amount of ingredient |
|---|---|---|
| 1 | Potassium sorbate | 0.2 g |
| 2 | Sugar syrup (64° Brix) | 156.2 g |
| | Ascorbic acid | 0.2 g |
| | Aqueous 50-weight-% | 5.0 g |
| | citric acid | |
| | Apricot flavor (water- | 0.2 g |
| | soluble, Givaudan 78848- | |
| | 56) | |
| | Stock solution* | 10 g (i.e. 10 ppm) |
| 3 | Water | Filled up so that a total |
| | | amount of the soft drink |
| | | of 1000 ml results |
| | Total amount | 1000 ml |

*From the formulation according to example 1 a stock solution was prepared, whereby the formulation was diluted with water so that the stock solution had a concentration of the rhodoxanthin of 0.1 weight-% (= 1000 ppm).

The soft drink was prepared as follows:

Potassium sorbate 1) was dissolved in 40 g of water, the other ingredients 2) were added one after the other while the mixture was gently stirred. Then the resulting soft drink syrup was diluted with drink water in such an amount to result in 1000 ml of the soft drink. The pH of the soft drink was in the range of 3.0 to 3.5.

The soft drink was then filled in a glass bottle and the bottle sealed with a metallic cap. The bottle was pasteurized for approximately 1 min at 80° C. using a tunnel pasteurizer (Miele, Switzerland). The bottles were stored at room temperature (temperature in the range of 18 to 27° C.) and under light exposure. Color and turbidity measurements were performed directly after beverage preparation (time=0).

### Turbidity Measurements

Suspended solids (or particles) are responsible for the turbid appearance of beverages containing juice. This turbid appearance can be evaluated by turbidity measurements. Turbidity depends on the light-scattering properties of such particles: their size, their shape and their refractive index.

In this work turbidity measurements were conducted using a Turbidimeter (Hach 2100N IS®, USA) and turbidity values were given in NTU (nephelometric turbidity units). Neophelometer measures the light scattered by a sample in 90° from the incident light path.

### Color Measurements

Color measurements for the application in food are performed with a colorimeter (Hunter Lab Ultra Scan Pro) which can other than a spectrophotometer express color values according to the psychophysical perception of color by human eye.

Color measurements are carried out after CIE guidelines (Commission International d'Eclairage). Values can be expressed either as planar coordinates L*a*b* with L* being the measuring value for lightness, with a* being the value on the red-green-axis and with b* being the value on the yellow-blue-axis.

### Instrument Settings:

Color scale: CIE L*a*b*/L*C*h*
Light source definition: D65 daylight equivalent
Geometry: Diffuse/8°
Wavelengths: scan 350 to 1050 nm in 5 nm optical resolution
Sample measurement area diameter: 19 mm (large)
Calibration mode: Transmission/white tile

### Results:

Turbidity: 125 NTU.

### Color Values:

L*/a*/b*=53.51/55.37/38.89; C*/h=67.67/35.08

### COMPARATIVE EXAMPLE

A soft drink was prepared using Canthaxanthin 10% CWS/S (commercially available from DSM Nutritional Products Ltd., Kaiseraugst, Switzerland), whereby the concentration of the canthaxanthin in the soft drink was also 10 ppm.

### Results:

Turbidity: 168 NTU.

### Color Values:

L*/a*/b*=66.77/40.03/42.49; C*/h=58.38/46.71

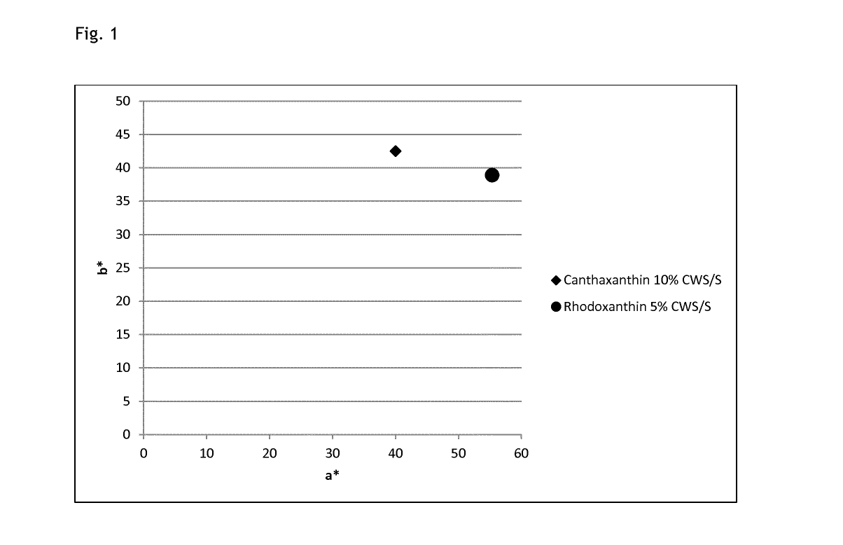

The results of example 4 and the comparative example are also shown in FIG. 1. The soft drink prepared with the rhodoxanthin formulation according to example 1 is less turbid and redder than the one prepared with Canthaxanthin 10% CWS/S.

### EXAMPLE 5

### Preparation of Chocolate Lentils with the Formulation According to Example 1

A rhodoxanthin stock solution containing 15 g of the formulation according to example 1 and 85 g of de-ionized water are prepared. 10 g of this rhodoxanthin stock solution are mixed with 490 g of a sugar solution (67-78° Brix) at a temperature of 65° C. under stirring and kept at this temperature resulting in a colored syrup.

Chocolate lentils are pre-coated with a pure sugar solution (without rhodoxanthin) thus providing chocolate lentils with a white center. After this pre-coating a white pigment like titaniumdioxide may be added to the pure sugar syrup and the chocolate lentils may be coated with 10 to 20 layers of this white sugar syrup before they are coated with the colored layers.

A small amount of colored syrup is poured over the lentils and homogenously distributed in the drum at moderate speed. Afterwards the thus colored lentils are dried with air (relative humidity in the range of 40-50%) at moderate speed resulting in one layer. These steps are repeated (usually 20 to 50 times) until the desired color intensity (either red or dark-red or nearly brown depending on how many layers are put on) is achieved.

The hard panned candy has a smooth surface aspect which is enhanced by final glazing layers. The external layers are made of crystalized sugar. According to the sugar layer thickness, the candy offers a lightly or hard crunchy bite.

Color measurements were carried out in a spectrophotometer from Hunter Lab called Ultra Scan PRO. The mode used was RSIN which stands for Reflectance-Specular Included. The small area view (SAV) with a diameter of 4.826 mm (0.190 inch) was chosen for the small and big lentils. The surface of the lentils was held in front of the area view and a light beam was induced on the surface and the reflectance was measured. These measurements resulted in different values. The lightness on a scale from 0 (black) to 100 (white), the a*-value which goes from green (negative value) to magenta (positive value), b*-value which goes from blue (negative value) to yellow (positive value), the chroma which stands for the distance from the center to the point X on an a*b* graph and hue, the angle between the positive a* axis to the point X of the surface was measured.

The Chroma (C) sometimes called saturation describes the vividness or dullness of a color which can be calculated as followed:

C=\sqrt{a²+b²}

The angle called hue (h) describes how we perceive an object's color and can be calculated as followed:

$$h = {tan ( \frac{b}{a} )}^{- 1}$$

### Results:

| Color values | Rhodoxanthin |
|---|---|
| L* | 58.53 |
| a* | 32.89 |
| b* | 17.87 |
| C* | 37.43 |
| h | 28.52 |

### EXAMPLE 6

### Preparation of a Yoghurt Drink with the Formulation According to Example 1

The yoghurt drink has the following composition:

| Ingredient | Amount [g] |
|---|---|
| Milk (3.5 weight-%) | 874 |
| Skim milk powder | 20 |
| Plain yoghurt (3.5 weight- | 50 |
| % of fat) | |
| sucrose | 50 |
| Stabilizer (plant | 3 |
| hydrocolloid) | |
| Rhodoxanthin 5% CWS/S | 1 for 5 ppm |
| 10% stock solution | 2 for 10 ppm |

Sucrose, milk powder and stabilizer are blended together and added to the milk preheated to 35° C. The 10% stock solution of rhodoxanthin (see also example 4 for its preparation) is added, the mixture is mixed and heated to 70° C. Then the mixture is homogenized at 200 bar/50 bar. Afterwards the mixture is heated to 95° C. for 5 minutes or alternatively to 80° C. for 20 minutes. After having cooled down to 45° C. yoghurt inoculum is added. The fermentation is performed at 43° C. until a pH of 4.6 is reached.

### Color Measurement

Color (lightness, Chroma, and hue) of the dairy product was determined with a HunterLab Ultra Scan Pro spectrocolorimeter (1 cm, REX) (Hunter Associates Laboratory, Reston, Va., USA) and expressed on basis of the CIELAB color scale.

The UltraScan PRO is a high performance color measurement spectrophotometer that measures the full range of human color perception. It measures after The CIE L*a*b*Color scale. This color scale is an approximately uniform color scale. Meaning the difference between points plotted in the color space correspond to visual difference between color plotted. The measurements were performed using reflectance mode with a wavelength range from 350 nm-1080 nm.

The colour change DE* is calculated as follows:

DE*=\sqrt{(ΔL)²+(Δa)²+(Δb)²}

### Chemical Analysis

The active content was analyzed in the analytics department using RP HPLC. The calibration was performed using Rhodoxanthin standard substance. The accuracy of this measurement is +/−5%.

### Results

The application of Rhodoxanthin 5% CWS/S in a dairy yoghurt drink leads to a reddish strawberry like color shade.

The color difference over 3 weeks storage time (a normal storage time for yoghurt drinks, stored at fridge at 5° C.) is very stable. The DE* value is <3 which is not even visible for human eyes.

TABLE 1
LaCh values after 3 weeks of storage time at 5° C.

| | Yoghurt drink with 5 ppm | Yoghurt drink with 10 ppm |
|---|---|---|
| | of rhodoxanthin | of rhodoxanthin |
| L* | 76.13 | 71.73 |
| a* | 18.11 | 22.6 |
| b* | 11.58 | 13.02 |
| C* | 21.49 | 26.09 |
| h* | 32.6 | 29.94 |

| DE* | 1 Week | 2 Weeks | 3 Weeks |
|---|---|---|---|
| Yoghurt drink with | 0.27 | 0.24 | 0.29 |
| 5 ppm of | | | |
| rhodoxanthin | | | |
| Yoghurt drink with | 0.27 | 0.35 | 0.41 |
| 10 ppm of | | | |
| rhodoxanthin | | | |

The chemical analysis over 3 weeks storage time did not show any instabilities. Both concentrations could be found back to ˜100%.

TABLE 2
Chemical analysis results over storage time

| Sample | Initial | 1 week | 2 weeks | 3 weeks |
|---|---|---|---|---|
| 5 ppm of | 5.75 | 5.37 | 5.68 | 5.73 |
| rhodoxanthin | | | | |
| Retention in [%] | 100 | 93.4 | 98.8 | 99.6 |
| 10 ppm of | 10.3 | 10.6 | 10.3 | 10.5 |
| rhodoxanthin | | | | |
| Retention in [%] | 100 | 103 | 100 | 102 |

1. Stable formulation comprising rhodoxanthin embedded in a matrix of modified food starch.

2. The stable formulation according to claim 1, wherein the color hue of said formulation is in the range of from 30 to 45 (preferably in the range of from 35 to 45, more preferably in the range of from 35 to 40) if said formulation is mixed with water so that the mixture contains 1 to 20 ppm, preferably 5 to 10 ppm, of rhodoxanthin.

3. The stable formulation according to claim 1 further comprising a fat-soluble antioxidant and/or a water-soluble antioxidant.

4. The stable formulation according to claim 1 wherein the amount of rhodoxanthin is in the range of 0.1 to 25 weight-%, based on the total weight of the formulation.

5. The stable formulation according to claim 1 wherein the amount of the modified food starch is in the range of 60 to 99.8 weight-%, preferably wherein the amount of the modified food starch is in the range of 70 to 90 weight-%, based on the total weight of the formulation.

6. Stable formulation consisting of rhodoxanthin, a starch that was treated with octenyl succinic anhydride, and an antioxidant, whereby the antioxidant can be fat-soluble or water-soluble.

7. The stable formulation according to claim 6, wherein the color hue of said formulation is in the range of from 30 to 45 (preferably in the range of from 35 to 45, more preferably in the range of from 35 to 40) if said formulation is mixed with water so that the mixture contains 1 to 20 ppm, preferably 5 to 10 ppm, of rhodoxanthin.

8. The stable formulation according to claim 1 wherein said formulation is essentially free of the following compounds: polyglycerol esters of edible fatty acids, citric acid esters of monoglycerides, citric acid esters of diglycerides of edible fatty esters and any mixture thereof.

9. The stable formulation according to claim 1 wherein said formulation is essentially free of physiologically tolerated polyhydric alcohols.

10. Use of the stable formulation according to claim 1 for coloring, enriching or fortifying beverages and food products.

11. Process for the manufacture of a formulation according to claim 1 comprising the following steps:
a. forming a solution of rhodoxanthin in an organic solvent, optionally adding a fat-soluble antioxidant and/or an oil;
b. dissolving a modified food starch and optionally a water-soluble antioxidant in water to obtain a matrix;
c. emulsifying the solution obtained in step a) into the matrix obtained in step b) to obtain an emulsion;
d. removing the organic solvent from the emulsion obtained in step c) to obtain a liquid formulation;
e. optionally drying the liquid formulation obtained in step d) to obtain the solid formulation.

12. The formulation as obtained by the process according to claim 11.

13. Beverages comprising the stable formulations according to claim 1.

14. Food products comprising the stable formulations according to claim 1.

15. The food products according to claim 14 being sweet products including sugar coated confectionary products, chocolate confectionary products and desserts, preferably the sugar coated confectionary products being boiled sweets, gums, chewing gums, jellies, toffees, hard sugar candies, soft sugar candies and fudges, and/or preferably the desserts being sorbets, puddings, instant pudding powders and preserves.
